(19) United States
(12) Patent Application Publication
(10) Pub. No.: US 2024/0335945 A1
(43) Pub. Date: Oct. 10, 2024

(54) INTERFERENCE CHECK DEVICE

(71) Applicant: FANUC CORPORATION, Minamitsuru-gun, Yamanashi (JP)

(72) Inventor: Duong NGOBACH, Yamanashi (JP)

(21) Appl. No.: 18/578,148

(22) PCT Filed: Aug. 6, 2021
(86) PCT No.: PCT/JP2021/029341

§ 371 Date: Jan. 10, 2024

(51) Int. Cl. B25J 9/16

(52) U.S. Cl. CPC B25J 9/1666

(57) ABSTRACT

The purpose of the present invention is to model the shapes of a robot and a surrounding obstacle with a small amount of data, and to improve the accuracy of checking interference. An interference check device for checking interference between a robot and a surrounding obstacle, the interference check device comprising: an inclusive cuboid set conversion unit for converting each of the robot and the surrounding obstacle into a three-dimensional model of a set of cuboids; and an interference determination unit for determining whether or not there is interference between the three-dimensional model of the robot and the three-dimensional model of the surrounding obstacle by simulation of motions of the three-dimensional models of the robot and surrounding obstacle based on a motion program.

### TECHNICAL FIELD

The present invention relates to an interference check device.

### BACKGROUND ART

In order to search for a motion path of a robot, an interference check between the robot and surrounding obstacles such as surrounding equipment and safety fences is performed in a virtual environment.

In this regard, in order to determine interference between a robot and a surrounding obstacle, a technique of performing an interference check using triangle meshes that constitute three-dimensional models of the robot and the surrounding obstacle is known. For example, see Patent Document 1.

In addition, a technique of quickly performing a process associated with interference calculation with respect to a free-form surface expressed by a higher-order curved surface expression or a three-dimensional shape composed of a large number of free-form surfaces by utilizing a polyhedron corresponding to a simplified convex closure is known. For example, see Patent Document 2.

In addition, a technique of performing an interference check between a robot and a surrounding obstacle using a voxel model that has a plurality of voxels or a voxel model formed of voxelized spheres and cylinders. For example, see Patent Document 3.

### CITATION LIST

### Patent Document

Patent Document 1: Japanese Unexamined Patent Application, Publication No. 2020-179441
Patent Document 2: Japanese Unexamined Patent Application, Publication No. 2002-342395
Patent Document 3: Japanese Unexamined Patent Application, Publication No. 2012-232408

### DISCLOSURE OF THE INVENTION

### Problems to be Solved by the Invention

In Patent Document 1, when performing an interference check using the three-dimensional models of triangle meshes, accurate determination results are obtained, but there is a problem in that the calculation cost is extremely high (particularly when a large number of triangle meshes are included).

In Patent Document 2, there are cases in which, depending on the shape of the surrounding obstacle, the space occupied by the convex closure is bigger than the actual shape, which reduces the accuracy of checking interference.

In Patent Document 3, there is a problem in that when the spheres and cylinders included in the voxel models are bigger than the actual robot and surrounding obstacle, and the robot and the surrounding obstacle are close to each other, it is constantly determined that the robot and the surrounding obstacle are interfering with each other.

There is thus a demand for modeling the shapes of a robot and a surrounding obstacle with a small amount of data, and improving the accuracy of checking interference.

### Means for Solving the Problems

An aspect of an interference check device according to the present disclosure is an interference check device for checking interference between a robot and a surrounding obstacle, the interference check device including: an inclusive cuboid set conversion unit configured to convert each of the robot and the surrounding obstacle into a three-dimensional model of a set of cuboids; and an interference determination unit configured to determine whether or not there is interference between the three-dimensional model of the robot and the three-dimensional model of the surrounding obstacle by simulation of motions of the three-dimensional models of the robot and the surrounding obstacle based on a motion program.

### Effects of the Invention

According to an aspect of the present invention, it is possible to model the shapes of a robot and a surrounding obstacle with a small amount of data, and to improve the accuracy of checking interference.

### BRIEF DESCRIPTION OF THE DRAWINGS

FIG. 1 is a functional block diagram illustrating a functional configuration example of an interference check device according to an embodiment of the present invention;

FIG. 2 illustrates an example of 3D CAD data of a surrounding obstacle;

FIG. 3 illustrates an example of cutting planes in the case of a robot;

FIG. 4 illustrates an example of a three-dimensional model of a set of cuboids of the surrounding obstacle illustrated in FIG. 2;

FIG. 5 illustrates an example of a three-dimensional model of a convex closure of the surrounding obstacle illustrated in FIG. 2;

FIG. 6 illustrates an example in which a margin is set for the set of cuboids of the surrounding obstacle illustrated in FIG. 4;

FIG. 7 is a flowchart describing an interference checking process of the interference check device; and

FIG. 8 is a flowchart describing a three-dimensional model conversion process of the interference check device.

### PREFERRED MODE FOR CARRYING OUT THE INVENTION EMBODIMENT

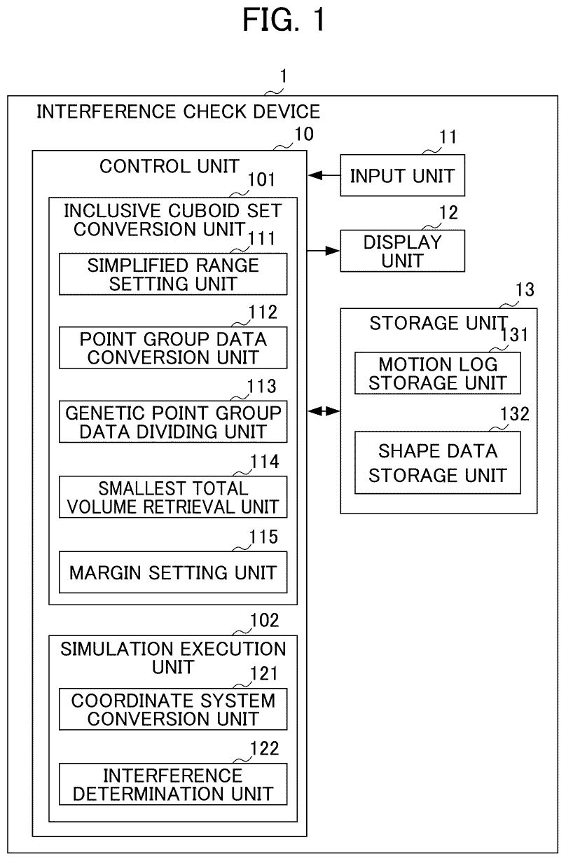

FIG. 1 is a functional block diagram illustrating a functional configuration example of an interference check device according to an embodiment of the present invention.

As illustrated in FIG. 1, the interference check device 1 is a well-known computer, and includes a control unit 10, an input unit 11, a display unit 12, and a storage unit 13. The control unit 10 includes an inclusive cuboid set conversion unit 101 and a simulation execution unit 102. The inclusive cuboid set conversion unit 101 includes a simplified range setting unit 111, a point group data conversion unit 112, a genetic point group data dividing unit 113, a smallest total volume retrieval unit 114, and a margin setting unit 115. The simulation execution unit 102 includes a coordinate system conversion unit 121 and an interference determination unit 122.

The interference check device 1 may be mutually connected, via a local area network (LAN), the Internet, or the like, to a robot control device (not illustrated) that controls a motion of a robot (not illustrated). Alternatively, the interference check device 1 may be mutually directly connected to the robot control device (not illustrated) via an unillustrated connection interface.

### <Input Unit 11>

The input unit 11 is, for example, a keyboard or a touch panel disposed on the display unit 12 described below. As described below, the input unit 11 receives, from a user such as a worker, a number of cuboids, etc. when converting three-dimensional models of an unillustrated robot and an unillustrated surrounding obstacle such as surrounding equipment or a safety fence into a set of cuboids.

### <Display Unit 12>

The display unit 12 is, for example, a liquid crystal display or the like, and displays determination results, etc. from the interference check device 1.

### <Storage Unit 13>

The storage unit 13 is a solid-state drive (SSD), a hard disk drive (HDD), or the like, and may store, inter alia, various motion programs for moving unillustrated robots and surrounding equipment. The storage unit 13 includes a motion log storage unit 131 and a shape data storage unit 132.

As described below, the motion log storage unit 131 stores as a motion log three-dimensional coordinate values and times that indicate positions and orientations of a set of cuboids of an unillustrated robot and a surrounding obstacle such as surrounding equipment of the robot and a safety fence by the interference determination unit 122 executing a simulation of a motion program, using three-dimensional models of the set of cuboids of the robot and the surrounding obstacle that have been converted by the inclusive cuboid set conversion unit 101 on the basis of shape data such as 3D CAD data that three-dimensionally represents the robot and the surrounding obstacle.

The shape data storage unit 132 stores shape data such as 3D CAD data of the unillustrated robot and 3D CAD data of the unillustrated surrounding obstacle.

### <Control Unit 10>

The control unit 10 is well known to a person skilled in the art, and is configured so as to have a central processing unit (CPU), a read only memory (ROM), a random-access memory (RAM), a complementary metal-oxide-semiconductor (CMOS) memory, and the like, which are able to communicate with one another via a bus.

The CPU is a processor that controls the interference check device 1 as a whole. The CPU reads a system program and an application program stored in the ROM via the bus, and control the interference check device 1 as a whole according to the system program and the application program. Thus, as illustrated in FIG. 1, the control unit 10 is configured so as to realize the functions of the inclusive cuboid set conversion unit 101 and the simulation execution unit 102. In addition, the inclusive cuboid set conversion unit 101 is configured so as to realize the functions of the simplified range setting unit 111, the point group data conversion unit 112, the genetic point group data dividing unit 113, the smallest total volume retrieval unit 114, and the margin setting unit 115. In addition, the simulation execution unit 102 is configured so as to realize the functions of the coordinate system conversion unit 121 and the interference determination unit 122. The RAM stores various data such as temporary calculation data and display data. In addition, the CMOS memory is backed up by a battery not illustrated here, and is configured as a non-volatile memory, the storage state of which is retained even when the power supply of the interference check device 1 is turned off.

### <Inclusive Cuboid Set Conversion Unit 101>

The inclusive cuboid set conversion unit 101, for example, as a preliminary process to the main process by the simulation execution unit 102 described below, converts the unillustrated robot and surrounding obstacle into three-dimensional models of sets of cuboids from the respective shape data (3D CAD data) of the robot and the surrounding obstacle stored in the shape data storage unit 132 of the storage unit 13.

Below, an operation of the inclusive cuboid set conversion unit 101 will be described in terms of the functions of the simplified range setting unit 111, the point group data conversion unit 112, the genetic point group data dividing unit 113, the smallest total volume retrieval unit 114, and the margin setting unit 115 that constitute the inclusive cuboid set conversion unit 101.

### <Simplified Range Setting Unit 111>

The simplified range setting unit 111, for example, displays 3D CAD data as shape data of a surrounding obstacle on the display unit 12, and sets, on the basis of an input operation by a user with respect to the input unit 11, a range of the shape data of the surrounding obstacle to be used in checking interference.

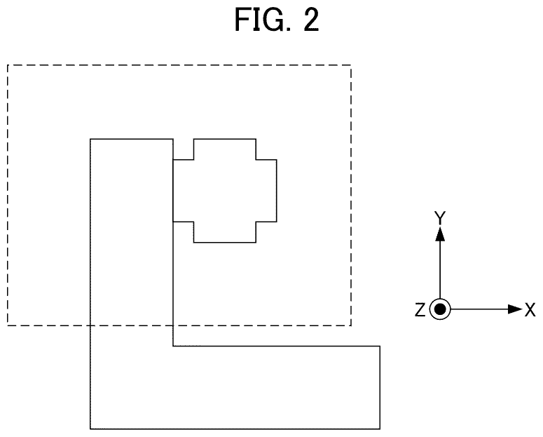

FIG. 2 illustrates an example of shape data of a surrounding obstacle. Out of the shape data (3D CAD data) of the surrounding obstacle, FIG. 2 illustrates the shape of the surrounding obstacle in an XY plane as seen in the positive Z-axis direction.

As illustrated in FIG. 2, the simplified range setting unit 111 receives a range indicated by the dashed lines out of the shape data (3D CAD data) of the surrounding obstacle, on the basis of, for example, the input operation by the user with respect to the input unit 11. The simplified range setting unit 111 sets the received range as a designated range.

By doing so, the interference check device 1 is able to simplify interference checking by only checking for interference in the range in which the actual robot (not illustrated) moves.

### <Point Group Data Conversion Unit 112>

The point group data conversion unit 112 converts to respective point group data of the robot and point group data of the surrounding obstacle in the designated range set by the simplified range setting unit 111 based on the respective 3D CAD data of the unillustrated robot and a surrounding obstacle stored in the shape data storage unit 132 of the storage unit 13, using, for example, a well-known point group data conversion technique.

### <Genetic Point Group Data Dividing Unit 113>

The genetic point group data dividing unit 113, for example, calculates an evaluation value for each combination of a plurality of cutting planes that divide the respective point group data of the robot and the surrounding obstacle converted by the point group data conversion unit 112 into a number of cuboids that is input by the user, and repeats a recalculation of the evaluation value for each combination of a plurality of cutting planes that are newly generated on the basis of a well-known genetic algorithm by a maximum number of repetitions that is set in advance.

Specifically, when, for example, a number n of cuboids has been input by the user via the input unit 11, the genetic point group data dividing unit 113 randomly generates k combinations of (n−1) cutting planes that divide the point group data of the unillustrated robot (or surrounding obstacle) into n (where n and k are integers equal to or greater than 2).

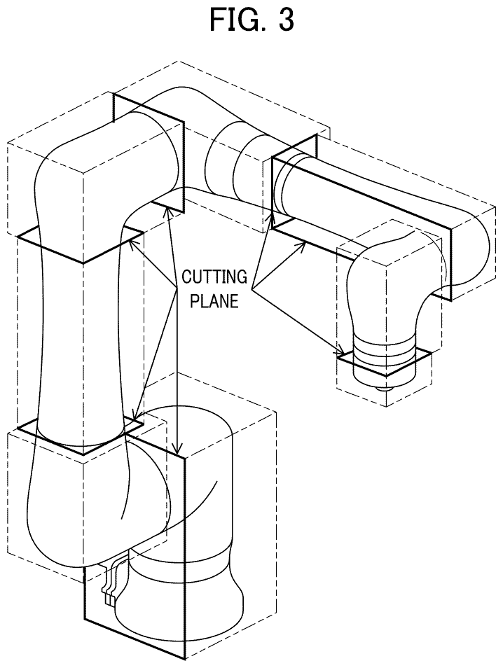

FIG. 3 illustrates an example of cutting planes in the case of a robot. In FIG. 3, the robot is illustrated in solid lines, and the three-dimensional model of the set of cuboids of the robot is illustrated in dashed lines. Further, FIG. 3 illustrates a case in which the number n of cuboids input by the user as the three-dimensional model of the set of cuboids of the robot is 8, and illustrates 7 cutting planes in thick solid line.

The genetic point group data dividing unit 113 calculates the volume of the cuboids that include the respective n sets of point group data divided by the (n−1) cutting planes in each of the k combinations, and calculates the total volume of the set of cuboids of the robot (or surrounding obstacle) as an evaluation value for each combination of the (n−1) cutting planes. The genetic point group data dividing unit 113 repeats a recalculation of the evaluation value for the (n−1) cutting planes of each of the k combinations that are newly generated by a genetic operation on the basis of a genetic algorithm, by a maximum number of repetitions that is set in advance.

It should be noted that the number of cutting planes that divide the point group data into n is not limited to (n−1), and may be a lower number than (n−1).

### <Smallest Total Volume Retrieval Unit 114>

The smallest total volume retrieval unit 114 retrieves, for example, the (n−1) cutting planes of the k combinations that have the highest evaluation value of the evaluation values, that is to say, the (n−1) cutting planes in which the total volume of the set of cuboids in the three-dimensional model of the unillustrated robot (or surrounding obstacle) is the smallest, as optimal cutting planes. The smallest total volume retrieval unit 114 selects a set of cuboids that are divided by the optimal (n−1) cutting planes as illustrated in FIG. 3 as the three-dimensional model of the unillustrated robot (or surrounding obstacle).

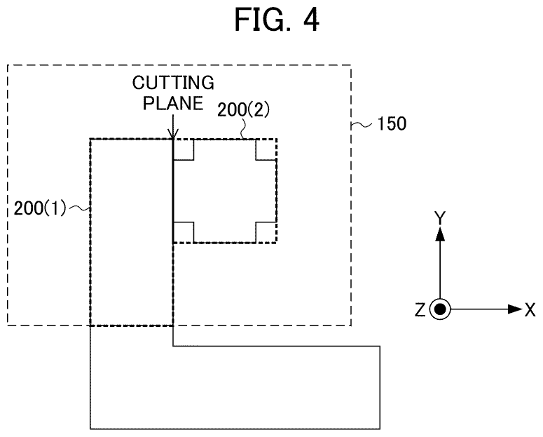

FIG. 4 illustrates an example of a three-dimensional model of a set of cuboids of the surrounding obstacle illustrated in FIG. 2.

As illustrated in FIG. 4, the three-dimensional model of the surrounding obstacle illustrated in FIG. 2 is a set of two cuboids 200(1) and 200(2) that are indicated by thick solid lines in the designated range set by the simplified range setting unit 111, and the cutting plane is between the cuboid 200(1) and the cuboid 200(2).

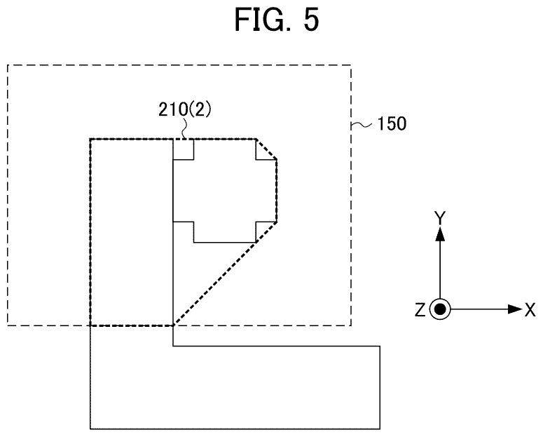

FIG. 5 illustrates an example of a three-dimensional model of a convex closure of the surrounding obstacle illustrated in FIG. 2.

As illustrated in FIG. 5, the three-dimensional model of the convex closure of the surrounding obstacle indicated by the solid dashed lines is bigger than the actual surrounding obstacle, as described above. By contrast, the three-dimensional model of the set of cuboids of the surrounding obstacle in FIG. 4 indicates a size that is approximately equal to the shape of the actual surrounding obstacle.

Thus, the interference check device 1 is able to check for interference with high accuracy.

### <Margin Setting Unit 115>

The margin setting unit 115 sets a margin with respect to the three-dimensional model of the set of cuboids of the unillustrated robot or surrounding obstacle.

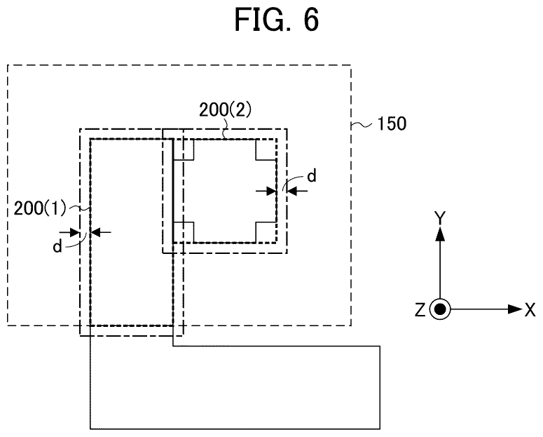

Specifically, the margin setting unit 115, for example, sets a margin amount d for each cuboid in the set of cuboids of the unillustrated robot or surrounding obstacle, the margin amount being set in advance in each of the X-axis, Y-axis, and Z-axis directions, as illustrated in FIG. 6.

Due to the above preliminary process by the inclusive cuboid set conversion unit 101, the use of the original triangle meshes in the 3D CAD data of the robot and the surrounding obstacle can be avoided, and the calculation cost for checking interference can be reduced.

### <Simulation Execution Unit 102>

On the basis of the motion program, the simulation execution unit 102 executes, as a main process, a simulation of moving the respective three-dimensional models of the set of cuboids of the robot and the surrounding obstacle that have been converted by the inclusive cuboid set conversion unit 101 as the preliminary process, and checks whether or not there is interference between the three-dimensional model of the robot and the three-dimensional model of the surrounding obstacle.

Below, an operation of the simulation execution unit 102 will be described in terms of the functions of the coordinate system conversion unit 121 and the interference determination unit 122 that constitute the simulation execution unit 102.

### <Coordinate System Conversion Unit 121>

When, for example, the simulation of the motion program has been executed by the simulation execution unit 102, the coordinate system conversion unit 121 updates the positions and the orientations of the three-dimensional models of the sets of cuboids of the unillustrated robot and surrounding obstacle, according to the motions of the robot and the surrounding obstacle.

### <Interference Determination Unit 122>

The interference determination unit 122 determines, using the motion simulation by the simulation execution unit 102 of the three-dimensional models of the sets of cuboids of the unillustrated robot and the surrounding obstacle based on the motion program, whether or not there is interference between the three-dimensional model of the robot and the three-dimensional model of the surrounding obstacle.

Specifically, the interference determination unit 122, for example, during the simulation of the motion program by the simulation execution unit 102, stores times and three-dimensional coordinate values that indicate the positions and orientations of the respective sets of cuboids of the robot and the surrounding obstacle as motion logs in the motion log storage unit 131. The interference determination unit 122 detects cuboids that spatially interfere with each other at the same time between the motion logs of the robot and the surrounding obstacle, and determine whether or not there is interference. The interference determination unit 122 may be configured to display the determination results on the display unit 12.

Thus, the user is able to comprehend the positional relationship between the robot and the surrounding obstacle.

### <Interference Checking Process of the Interference Check Device 1>

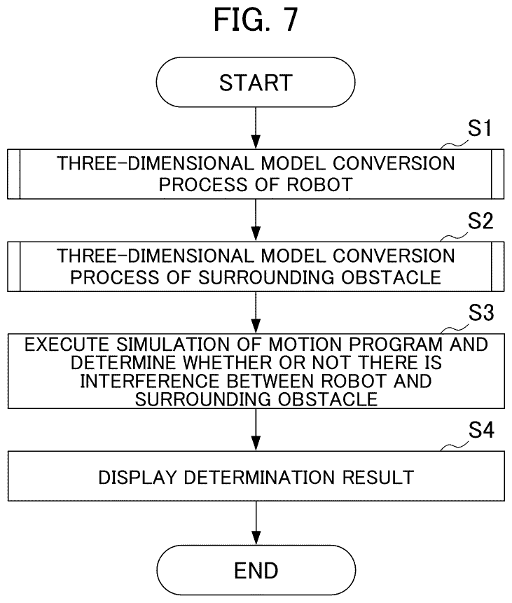

Next, the flow of the interference checking process of the interference check device 1 will be described with reference to FIG. 7.

FIG. 7 is a flowchart describing an interference checking process of the interference check device 1. The flow indicated here is executed every time an interference check instruction for a robot (not illustrated) is received from a user via the input unit 11.

At Step S1, when an instruction to convert a robot into a three-dimensional model of a set of cuboids has been received from a user via the input unit 11, the inclusive cuboid set conversion unit 101 executes a three-dimensional model conversion process of converting shape data (3D CAD data) of the robot stored in the shape data storage unit 132 into a three-dimensional model of a set of cuboids of the robot. The detailed flow of the three-dimensional model conversion process will be described below.

At Step S2, similarly to the case of the robot at Step S1, the inclusive cuboid set conversion unit 101 executes a three-dimensional conversion process of converting shape data (3D CAD data) of a surrounding obstacle stored in the shape data storage unit 132 into a three-dimensional model of a set of cuboids of the surrounding obstacle.

At Step S3, the simulation execution unit 102 (interference determination unit 122) executes, on the basis of the motion program, a simulation of moving the three-dimensional model of the set of cuboids of the robot converted at Step S1 and the three-dimensional model of the set of cuboids of the surrounding obstacle converted at Step S2, and determines whether or not there is interference between the three-dimensional model of the robot and the three-dimensional model of the surrounding obstacle.

At Step S4, the simulation execution unit 102 (interference determination unit 122) displays the determination results on the display unit 12.

### <Three-Dimensional Model Conversion Process of the Interference Check Device 1>

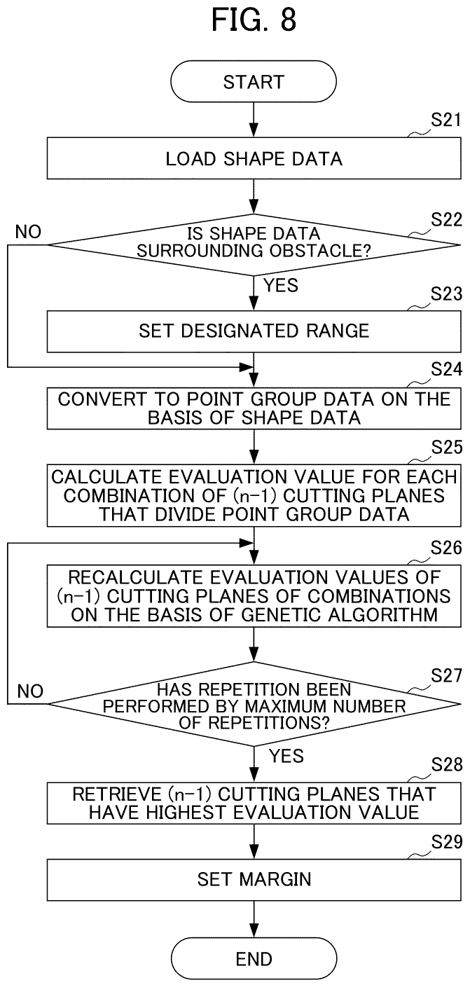

FIG. 8 is a flowchart describing the details of the three-dimensional model conversion processes indicated in Steps S1 and S2 in FIG. 7.

At Step S21, the inclusive cuboid set conversion unit 101 receives an instruction from the user via the input unit 11 to convert the robot (or the surrounding obstacle) into a three-dimensional model of a set of cuboids, and loads the shape data (3D CAD data) of the robot (or the surrounding obstacle) for which the instruction was received from the shape data storage unit 132.

At Step S22, the inclusive cuboid set conversion unit 101 determines whether or not the shape data that was loaded at Step S21 is the surrounding obstacle. When the shape data is the surrounding obstacle, the process proceeds to Step S23. On the other hand, if the shape data is not the surrounding obstacle, i.e., it is the robot, the process proceeds to Step S24.

At Step S23, the simplified range setting unit 111, for example, displays the shape data (3D CAD data) of the surrounding obstacle on the display unit 12, and receives and sets a designated range of the shape data of the surrounding obstacle to be used in checking interference on the basis of an input operation by the user with respect to the input unit 11.

At Step S24, the point group conversion unit 112 converts to point group data of the robot (or point group data of the surrounding obstacle in the designated range that was set at Step S23) based on the shape data (3D CAD data) of the robot (or the surrounding obstacle).

At Step S25, the genetic point group dividing unit 113 randomly generates k combinations of (n−1) cutting planes that divide the point group data of the robot (or the surrounding obstacle) that was converted at Step S24 into a number n of cuboids that is input by the user via the input unit 11. The genetic point group data dividing unit 113 calculates the total volume of the set of cuboids of the robot (or the surrounding obstacle) divided by the (n−1) cutting planes in each of the k combinations as an evaluation value for each combination of the (n−1) cutting planes.

At Step S26, the genetic point group dividing unit 113 recalculates the evaluation value for the (n−1) cutting planes of each of the k combinations that are newly generated by a genetic operation on the basis of a genetic algorithm.

At Step S27, the genetic point group dividing unit 113 determines whether or not m point group set candidates have been established by repeating by a maximum number m of repetitions. When m point group set candidates have been established, the process proceeds to Step S28. On the other hand, if m point group set candidates have not been established, the process returns to Step S26.

At Step S28, the smallest total volume retrieval unit 114 retrieves the (n−1) cutting planes of the k combinations that have the highest evaluation value of the evaluation values, that is to say, the (n−1) cutting planes in which the total volume of the set of cuboids in the three-dimensional model of the unillustrated robot (or surrounding obstacle) is the smallest, as optimal cutting planes. The smallest total volume retrieval unit 114 selects a set of cuboids that are divided by the optimal (n−1) cutting planes as the three-dimensional model of the unillustrated robot (or surrounding obstacle).

At Step S29, the margin setting unit 115 sets a margin with respect to the three-dimensional model of the sets of cuboids of the robot (or the surrounding obstacle) that was selected at Step S28.

Due to the above, the interference check device 1 according to an embodiment of the present invention converts a robot and a surrounding obstacle into three-dimensional models of sets of cuboids, on the basis of shape data (3D CAD data) of the robot and the surrounding obstacle. Thus, the interference check device 1 can model the shapes of a robot and a surrounding obstacle with a small amount of data, and improve the accuracy of checking interference.

In addition, by using the three-dimensional models of the sets of cuboids, the interference check device 1 can reduce the calculation cost of checking interference, and realize interference checking at a high speed.

An embodiment of the present invention has been described above, but the interference check device 1 is not limited to the above embodiment, and includes variations, modifications, and the like within a scope in which the purpose of the invention can be achieved.

### Modified Example 1

In the above embodiment, the interference check device 1 was configured as a different device from the robot control device (not illustrated), but the present invention is not so limited. For example, the interference check device 1 may be included in the robot control device (not illustrated).

### Modified Example 2

Further, in the above embodiment, the inclusive cuboid set conversion unit 101 was configured to convert the shape data (3D CAD data) of the robot (or the surrounding obstacle) stored in the shape data storage unit 132 into point group data, and divide the point group data into n sets of point group data to convert it into a three-dimensional model of a set of cuboids of the robot (or the surrounding obstacle), but the present invention is not so limited. For example, the inclusive cuboid set conversion unit 101 may convert the robot (or the surrounding obstacle) into a three-dimensional model of a set of cuboids on the basis of a number of cuboids, positions of the cuboids, sizes of the cuboids, and the like that are designated by the user on the basis of the shape data (3D CAD data).

The functions included in the interference check device 1 according to an embodiment of the present invention may be realized by hardware, software, or a combination thereof. Here, being “realized by software” means being realized by a computer reading and executing a program.

The program may be stored using various types of non-transitory computer-readable media and provided to a computer. Non-transitory computer-readable media include various types of tangible storage media. Examples of non-transitory computer-readable media include magnetic storage media (e.g., flexible discs, magnetic tapes, hard disk drives), magneto-optical storage media (e.g., magneto-optical discs), CD-ROM (Read Only Memory), CD-R, CD-R/W, semiconductor memories (e.g., mask ROM, PROM (Programmable ROM), EPROM (Erasable PROM), flash ROM, and RAM). In addition, the program may be provided to the computer by various types of transitory computer-readable media. Examples of transitory computer-readable media include electric signals, optical signals, and electromagnetic waves. Transitory computer-readable media may provide the program to the computer via wired communication paths such as electric wires and optical fibers, etc., or via wireless communication paths.

It should be noted that the steps describing the program stored in the storage medium obviously include a process executed chronologically according to the order thereof, and also includes processes executed in parallel or separately, and not necessarily in chronological order.

Rephrasing the above description, the interference check device according to the present disclosure may take on various embodiments that have the following configurations.

(1) The interference check device 1 according to the present disclosure is an interference check device for checking interference between a robot and a surrounding obstacle, the interference check device including: an inclusive cuboid set conversion unit 101 configured to convert each of the robot and the surrounding obstacle into a three-dimensional model of a set of cuboids; and an interference determination unit 122 configured to determine whether or not there is interference between the three-dimensional model of the robot and the three-dimensional model of the surrounding obstacle by simulation of motions of the three-dimensional models of the robot and the surrounding obstacle based on a motion program.

According to this interference check device 1, it is possible to model the shapes of a robot and a surrounding obstacle with a small amount of data, and to improve the accuracy of checking interference.

(2) The interference check device 1 described in (1) above may further include an input unit 11 configured to receive an input of a number of cuboids in the set of cuboids, and the inclusive cuboid set conversion unit 101 may include: a point group data conversion unit 112 configured to convert to respective point group data of the robot and the surrounding obstacle based on shape data of the robot and the surrounding obstacle; a genetic point group data dividing unit 113 configured to calculate an evaluation value for each combination of a plurality of cutting planes that divide the respective point group data of the robot and the surrounding obstacle into a number of the cuboids that is input into the input unit 11, and recalculate the evaluation value for each combination of the plurality of cutting planes that are newly generated on the basis of a genetic algorithm; and a smallest total volume retrieval unit 114 configured to retrieve the plurality of cutting planes that have the highest evaluation value of the evaluation values for each combination of the plurality of cutting planes in respectively the robot and the surrounding obstacle.

Thus, the interference check device 1 can respectively model the robot and the surrounding obstacle with the most fitting set of cuboids.

(3) In the interference check device 1 described in (1) or (2) above the inclusive cuboid set conversion unit 101 may include: a simplified range setting unit 111 configured to set a range of shape data of the surrounding obstacle to be used in the simulation; and a margin setting unit 115 configured to set a margin with respect to the three-dimensional models of the sets of cuboids of the robot and the surrounding obstacle.

Thus, the interference check device 1 can reduce the memory capacity required for the simulation by modeling only the portion of the surrounding obstacle that is required for checking interference.

(4) In the interference check device described in (2) above, the genetic point group data dividing unit 113 may recalculate the evaluation value for each combination of the plurality of cutting planes by a number of repetitions that is set in advance.

Thus, the interference check device 1 can generate an optimal three-dimensional model of a set of cuboids for each of the robot and the surrounding obstacle.

### EXPLANATION OF REFERENCE NUMERALS

1 Interference check device
10 Control unit
101 Inclusive cuboid set conversion unit
111 Simplified range setting unit
112 Point group data conversion unit
113 Genetic point group data dividing unit
114 Smallest total volume retrieval unit
115 Margin setting unit
102 Simulation execution unit
121 Coordinate system conversion unit
122 Interference determination unit
11 Input unit
12 Display unit
13 Storage unit
131 Motion log storage unit
132 Shape data storage unit

1. An interference check device for checking interference between a robot and a surrounding obstacle, the interference check device comprising:
an inclusive cuboid set conversion unit configured to convert each of the robot and the surrounding obstacle into a three-dimensional model of a set of cuboids; and
an interference determination unit configured to determine whether or not there is interference between the three-dimensional model of the robot and the three-dimensional model of the surrounding obstacle by simulation of motions of the three-dimensional models of the robot and the surrounding obstacle based on a motion program.

2. The interference check device according to claim 1, comprising an input unit configured to receive an input of a number of cuboids in the set of cuboids,
wherein the inclusive cuboid set conversion unit comprises:
a point group data conversion unit configured to convert to respective point group data of the robot and the surrounding obstacle based on shape data of the robot and the surrounding obstacle;
a genetic point group data dividing unit configured to calculate an evaluation value for each combination of a plurality of cutting planes that divide the respective point group data of the robot and the surrounding obstacle into a number of the cuboids that is input into the input unit, and recalculate the evaluation value for each combination of the plurality of cutting planes that are newly generated on the basis of a genetic algorithm; and
a smallest total volume retrieval unit configured to retrieve the plurality of cutting planes that have the highest evaluation value of the evaluation values for each combination of the plurality of cutting planes in respectively the robot and the surrounding obstacle.

3. The interference check device according to claim 1, wherein the inclusive cuboid set conversion unit comprises:
a simplified range setting unit configured to set a range of shape data of the surrounding obstacle to be used in the simulation; and
a margin setting unit configured to set a margin with respect to the three-dimensional models of the sets of cuboids of the robot and the surrounding obstacle.

4. The interference check device according to claim 2, wherein the genetic point group data dividing unit recalculates the evaluation value for each combination of the plurality of cutting planes by a number of repetitions that is set in advance.
